(19) United States
(12) Patent Application Publication
(10) Pub. No.: US 2022/0388312 A1
(43) Pub. Date: Dec. 8, 2022

(54) PRINTING SYSTEM, CONTROL DEVICE, AND PRINTING METHOD

(71) Applicant: MIMAKI ENGINEERING CO., LTD., Nagano (JP)

(72) Inventors: Tsukasa Takeda, Nagano (JP); Tomohiko Takizawa, Nagano (JP)

(73) Assignee: MIMAKI ENGINEERING CO., LTD., Nagano (JP)

(21) Appl. No.: 17/776,592

(22) PCT Filed: Nov. 25, 2020
(86) PCT No.: PCT/JP2020/043917

§ 371 Date: May 12, 2022

(30) Foreign Application Priority Data
Nov. 26, 2019 (JP) 2019-213709

(51) Int. Cl. B41J 3/407; B41J 11/00; D06P 5/30; D06L 1/00

(52) U.S. Cl. CPC B41J 3/4078; B41J 11/0015; D06P 5/30; D06L 1/00

(57) ABSTRACT

The disclosure more appropriately determines a condition of a step executed at the time of creating a product of printing. A printing system (10) that creates a product of printing by performing at least printing includes a printer (16) which is a printing apparatus that executes a printing step of performing printing by ejecting ink; a washing machine (20) which is a post-processing machine that executes a post-processing step on a printed matter obtained by performing the printing step in the printer (16); and a control device (12) that determines a condition of a post-processing step based on a condition of the printing step.

### TECHNICAL FIELD

The present invention relates to a printing system, a control device, and a printing method.

### BACKGROUND ART

Conventionally, printing apparatuses have been used in various fields. Furthermore, when printing is performed by the printing apparatus, various pre-processing steps and post-processing steps may be performed in addition to the printing step executed by the printing apparatus depending on the purpose of printing, the medium (media) to be used, and the like (see e.g., Patent Literature 1.).

### CITATION LIST

### Patent Literature

Patent Literature 1: Japanese Unexamined Patent Publication No. 2002-169608

### SUMMARY OF INVENTION

### Technical Problems

When a pre-processing step or a post-processing step is performed in addition to a printing step, for example, the operation of each step is sequentially performed according to a production condition that designates the condition of each step to create a product of printing. In this case, it is desirable to be able to determine the condition of each step when performing the operation of each step more appropriately.

### Solutions to Problems

The inventor of the present application conducted a thorough research on a configuration for more appropriately performing management of each step with respect to a printing system for creating a product by performing a predetermined step other than the printing step. Then, the inventors considered collectively managing a plurality of steps including a printing step instead of individually managing the plurality of steps for every step.

With such a configuration, each step can be more appropriately managed as compared with a case where each step is managed by different administrators by consistently performing production management with respect to a plurality of steps.

The inventor of the present application considered determining the condition of the post-processing step based on the condition of the printing step in the case of performing the post-processing step after the printing step.

According to such configuration, the post-processing step can be more appropriately executed according to the content of the step executed in the printing step.

Through further thorough researches, the inventor of the present application found features necessary for obtaining such effects and contrived the present invention. In order to solve the above problem, the present invention relates to a printing system that creates a product of printing by performing at least printing, the printing system including a printing apparatus that executes a printing step of performing printing by ejecting ink; a post-processing machine that is a device configured to execute a post-processing step on a printed matter obtained by performing the printing step in the printing apparatus; and a control device that determines a condition of the post-processing step based on a condition of the printing step.

When configured in such manner, the condition of the post-processing step can be appropriately determined based on the condition of the printing step. Thus, the post-processing step can be more appropriately executed according to the content of the step executed in the printing step. A condition of a step executed at the time of creating a product of printing thus can be more appropriately determined.

In this configuration, it is conceivable to execute a step of ejecting ink onto a fabric medium as the printing step. In this case, the washing step of washing a medium after the ink is ejected in the printing step can be considered as a post-processing step. In this case, the control device determines the condition of the washing step based on the condition of the printing step. The post-processing machine executes the washing step under the condition of the washing step determined by the control device.

Here, when executing the washing step after the printing step, it is assumed that a large amount of water and energy are required in order to appropriately secure the quality of the product of printing. In this case, when water or energy is consumed more than necessary, an excessive load on the environment is generated by that amount. On the other hand, when the used amount of water or energy is excessively reduced, washing becomes insufficient, and re-washing (rewashing) may become necessary. As a result, additional work time, water, energy, and the like are required. Therefore, in the washing step, it is important to appropriately determine the conditions of the step so that the used amount of water or energy falls within an appropriate range.

In this regard, for example, a condition of an appropriate step can be set, for example, by actually performing washing and setting the condition of the washing step. However, in order to determine the optimum condition of the washing step for various printed matters created in the printing step, it is necessary to check every time, and work time, water, energy, and the like therefor are necessary. In addition, when actually performing the washing and setting the condition of the washing step, for example, it is conceivable that the worker of the washing step sets the condition of the washing step by checking the washing result. However, the dependence on the technology, know-how, and the like personally possessed by the worker increases, and unevenness and the like easily occur in the quality of washing by the person in charge of performing the work. Due to the decrease in the labor population in recent years, it can be assumed that ensuring of workers, and inheritance of technology becomes difficult in such a method that relies on personal technology, know-how, and the like.

On the other hand, as described above, when determining the condition of the post-proces sing step based on the condition of the printing step in the control device, the condition of the washing step suited to the printed matter created in the printing step can be appropriately determined without actually performing washing. In this case, for example, unevenness or the like can be appropriately prevented from occurring in the quality of washing even when the person in charge of the work changes by determining the condition of the washing step without relying on the technology, know-how, or the like personally possessed by the worker. As a result, for example, even in a case where the decrease in labor population has progressed, workers can be secured, and technology can be inherited more easily and appropriately.

In this configuration, the control device at least determines a used amount of washing water, which is water for washing, as a condition of the washing step. With such a configuration, in the washing step, the used amount of washing water can be appropriately prevented from becoming excess or insufficient, and the like. For example, the amount of washing water required at the time of washing is considered to change depending on the temperature of the washing water or the like. Therefore, the control device may determine the used amount of washing water based on the temperature of washing water. In the washing step, for example, it is conceivable to adjust the temperature of washing water by heating washing water or the like. In such a case, the control device preferably determines at least the temperature of the washing water as a condition of the washing step. The control device may determine the condition other than the amount and temperature of the washing water as the condition of the washing step. For example, in the control device, it is considered to determine the washing time as a condition of the washing step. According to such configuration, the necessary washing time can be appropriately secured. The control device may further determine how to move the medium in the washing step (e.g., a moving speed or the like). According to such configuration, the energy and the like consumed in the washing step can be appropriately changed according to the condition of the printing step.

In the control device, it is conceivable to determine the condition of the washing step according to the matter prioritized at the time of washing. In this case, the control device receives, from the user, an instruction to select on of a plurality of washing modes in which matters to be prioritized at the time of executing the washing step are different from each other. The condition of the washing step is then determined according to the washing mode selected by the user. In this case, the user is, for example, an administrator of the printing system. As the washing mode, it is conceivable to prepare a mode in which quality is prioritized, a mode in which reduction in used amount of washing water is prioritized, a mode in which washing time is shortened, and the like. According to such configuration, the condition of the washing step can be more appropriately determined according to the purpose of the user, and the like.

In this configuration, it is conceivable to determine the condition of the washing step based on various conditions and the like used as the condition of each step executed in the printing system. In the control device, it is conceivable to at least determine the condition of the washing step based on the type of fabric used as the medium. As the type of fabric, for example, it is conceivable to take into consideration the material of the cloth, the type of cloth, and the like.

In the control device, it is also conceivable to at least determine the condition of the washing step based on the amount of ink ejected onto the medium in the printing step. In the printing apparatus, for example, consideration is made to perform printing on a medium using inks of a plurality of colors in the printing step. In this case, in the control device, it is also conceivable to at least determine the condition of the washing step based on the amount of ink of each color to be ejected to the medium in the printing step. In the control device, it is also conceivable to at least determine the condition of the washing step based on the type of ink ejected in the printing step. When configured in such manner, the condition of the washing step can be appropriately determined based on the condition of the printing step. In order to determine the condition of the washing step with higher accuracy, it is preferable to consider a plurality of conditions related to the printing step. In this case, it is conceivable that the control device at least determines the condition of the washing step based on the type of fabric used as the medium, the amount of ink ejected onto the medium in the printing step, and the type of ink ejected in the printing step.

In addition, the condition of the washing step may be determined based further on the condition of a step other than the printing step. It is conceivable to execute a step of ejecting ink to be subjected to a color development process after the printing step as the printing step. In this case, the printing system further includes a color development processing machine that executes a color developing step of causing ink used in the printing step to develop color. The control device, for example, determines the condition of the washing step further based on the condition of the color developing step. According to such configuration, the condition of the washing step can be more appropriately determined by taking into consideration conditions of more steps.

In this case, the color developing step can also be considered as a post-processing step executed after the printing step. Therefore, the operation of determining the condition of the washing step further based on the condition of the color developing step can also be considered as an operation of determining the condition of any of the post-processing steps based further on the condition of another post-processing step when a plurality of post-processing steps are performed.

At the time of creating a product of printing, it is conceivable to further execute a pre-processing step other than the printing step and the post-processing step. In this case, consideration is made to determine the condition of the washing step based further on the condition of the pre-processing step. In this case, the printing system further includes, for example, a pre-processing machine which is a device that executes a pre-processing step on a fabric used as a medium in the printing step. The control device determines the condition of the washing step further based on the condition of the pre-processing step. According to such configuration, the condition of the washing step can be more appropriately determined by taking into consideration conditions of more steps. As the pre-processing step, it is conceivable to execute a step of applying a pre-processing agent on a fabric used as a medium. In this case, in the control device, it is also conceivable to at least determine the condition of the washing step based on the type of pre-processing agent used in the pre-processing step. When configured in such manner, the condition of the post-processing step can be appropriately determined based on the condition of the pre-processing step.

It is also conceivable to execute a step other than the washing step as a post-processing step to be a target for determining the condition of the step. In this case, in the control device, it is conceivable to determine a condition of a color developing step executed as the post-processing step based on a condition of the printing step.

The configuration of the present invention can also be considered from a viewpoint different from the above. For example, the configuration of the present invention can be considered by focusing on the feature of determining the condition of the post-processing step based on the condition of the pre-processing step. In this case, the control device determines the condition of the post-processing step based on the condition of the pre-processing step. According to such configuration, when executing the pre-processing step and the post-processing step other than the printing step, the condition of the post-processing step can be more appropriately determined. In this case, the pre-processing machine can be considered as a device that executes the pre-processing step before the printing step to create a product of printing.

The configuration of the present invention can be considered by focusing on the feature of determining the condition of any step based on the condition of another step. In this case, a configuration of determining the condition of the printing step based on the condition of the post-processing step, for example, can be considered as a configuration of the present invention. In this case, the control device determines the condition of the printing step based on the condition of the post-processing step. According to such configuration, when executing the printing step and the post-processing step, the condition of the printing step can be more appropriately determined. When the ink is ejected onto the fabric medium in the printing step and the washing step is performed as the post-processing step, it is conceivable that the condition of the printing step is determined in the control device so that the printing speed matches the washing speed. According to such configuration, the printing speed can be appropriately adjusted according to the time required to execute the washing step under an optimum condition.

It is conceivable to use a control device, a printing method and the like having features similar to the above as the configuration of the present invention. In this case as well, for example, effects similar to the above can be obtained. Effect of the Invention

According to the present invention, a condition of a step executed at the time of creating a product of printing can be more appropriately determined.

### BRIEF DESCRIPTION OF THE DRAWINGS

FIG. 1 is a view describing a printing system 10 according to one embodiment of the present invention.

FIG. 2 is a view describing a manner of determining a condition of a washing step. (a) of FIG. 2 is a view describing contamination of washing water generated during washing. (b) of FIG. 2 shows one example of the manner of determining the condition of the washing step.

FIG. 3 is a view showing an example of a parameter to take into consideration when determining the condition of the washing step.

FIG. 4 is a view showing an example of a parameter to take into consideration when determining the condition of the washing step.

### DESCRIPTION OF EMBODIMENTS

Hereinafter, an embodiment according to the present invention will be described with reference to the drawings.

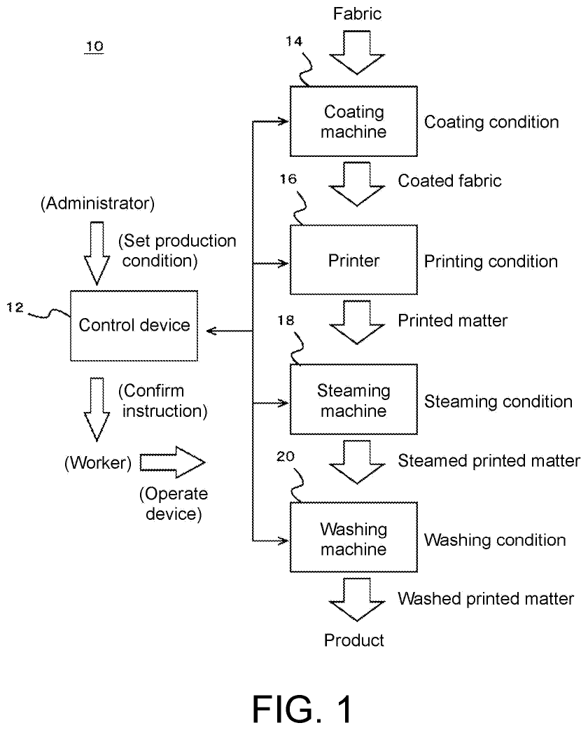

FIG. 1 is a view describing a printing system 10 according to one embodiment of the present invention. FIG. 1 illustrates an example of a device configuring the printing system 10 and a process of creating a product.

Other than the points described above, the printing system 10 of the present example may have features same as or similar to the known printing systems. Furthermore, other than the points described below, each device configuring the printing system 10 of the present example may have features same as or similar to each device configuring the known printing systems.

In the present example, the printing system 10 is an example of a printing system that creates a product by performing at least printing. In the printing system 10, a product is created by performing a pre-processing step and a post-processing step in addition to the printing step.

More specifically, the printing system 10 performs printing through an inkjet method on a fabric medium (media) to produce a textile. In this case, the produced textile corresponds to a product of printing created in the printing system 10.

In order to perform each step for creating a product, the printing system 10 includes a control device 12, a coating machine 14, a printer 16, a steaming machine 18, and a washing machine 20.

The control device 12 is a computer that manages production conditions for creating a product of printing in the printing system 10. The control device 12 manages, for example, the condition of a step performed by each device of the printing system 10 as a production condition.

The control device 12 is communicably connected to each device included in the printing system 10 via a network (e.g., LAN). The control device 12 inputs and outputs data, commands, and the like as necessary. In this case, for example, MDL command or the like can be suitably used as the command. The MDL command is a command created based on the MDL command SDK provided by Mimaki Engineering Co., Ltd.

In the printing system 10 of the present example, an instruction from an administrator of the printing system 10 and information such as production conditions are input to the control device 12. The control device 12 outputs an instruction to each device or worker based on an instruction from an administrator or input information. In this case, the administrator of the printing system 10 can be considered as, for example, a higher-level user or the like who determines a product to be created in the printing system 10. The worker is, for example, a user at the site who performs an operation and the like on each device in the printing system 10 as necessary.

The control device 12 sets the production condition, for example, according to an instruction of an administrator of the printing system 10. “Setting the production condition according to an instruction of the administrator” means setting the “production condition designated by the administrator” according to an instruction input of the administrator or another user who has received the instruction of the administrator, input information, and the like.

The production conditions set by the printing system 10 include at least conditions (production conditions) in each step such as a coating condition, a printing condition, a steaming condition, and a washing condition, in addition to the information of the fabric to use.

The fabric to use is a fabric used as a medium in the printing system 10. The coating condition, the printing condition, the steaming condition, and the washing condition are conditions of each step executed in the coating machine 14, the printer 16, the steaming machine 18, and the washing machine 20.

As will be described below, in the present example, the control device 12 determines the condition of each step executed in the printing system 10, as necessary. Therefore, the production condition set according to the instruction of the administrator can also be considered as an initial value of the production condition.

Furthermore, the production condition can also be considered as a condition for creating a target product (desired product). In this case, determining the condition of each step may be, for example, selecting one of a plurality of conditions prepared in advance as the condition of each step.

In the present example, the control device 12 determines the condition of the washing step based on the conditions of other steps such as the printing step. Therefore, in the control device 12, as the production condition set as the initial value, a condition other than the condition of the washing step (washing condition) may be set.

Furthermore, the control device 12 controls the operation of each device in the printing system 10 based on the set production conditions. In this case, the control device 12 controls the operation of each device using, for example, a command such as an MDL command.

The control of each device with a command or the like may be difficult depending on the condition of the step performed in each device. In this case, the control device 12 may issue an instruction to the worker of the device by, for example, display on a monitor provided in the device, display on a terminal held by the worker, or the like, so that the operation of the device is performed through the hands of the worker.

In the present example, the control device 12 can also be considered, for example, as a job control device that controls work executed by each device in the printing system 10.

The coating machine 14 is an example of a pre-processing machine, and performs pre-processing on a medium to be printed. The medium to be printed is a fabric that is a printing target object in the printing step.

The pre-processing machine is, for example, a device that executes a pre-processing step before a printing step. This pre-processing step is carried out in order to create a product of printing with a desired quality.

In the present example, the coating machine 14 executes the coating step on the medium before executing the printing step.

The coating step is an example of a pre-processing step, and in this step, for example, a pre-processing agent is applied to a fabric medium. The coating machine 14 executes the coating step on the fabric designated under the production conditions described above under the coating conditions similarly designated in the production conditions.

The coating machine 14 performs the coating step according to the set production conditions to create a fabric coated with the pre-processing agent. As the coating agent, for example, a known paste and the like can be suitably used.

In the present example, the coating machine 14 applies a coating agent, which is an example of a pre-processing agent, to the fabric before printing to create an ink receiving layer on the fabric.

The printer 16 is a printing apparatus that executes a printing step. In the present example, the printer 16 is an inkjet printer. The printer 16 performs printing by ejecting ink through an inkjet method onto a fabric coated with a pre-processing agent.

In this case, printing is performed by ejecting ink to an ejection position designated by the print data. The print data is data created based on an image to be printed, and when printing is performed based on the print data, an image can be drawn on a fabric coated with a pre-processing agent.

In the present example, the printer 16 performs a printing step based on, for example, print data input from the control device 12. Specifically, the printing step is executed under the printing conditions (conditions in the printing step) designated in the set production conditions. As a result, a printed matter on which information such as an image, a pattern, and a character is printed according to the production conditions is created.

In the present example, the printer 16 executes the printing step on the fabric using ink for textile printing. As the ink for textile printing, an ink that needs to be subjected to the color development process after the printing step is used. As such ink, known ink for textile printing can be suitably used.

When printing is performed through an inkjet method using an ink for textile printing as in the present example, it can be considered that inkjet textile printing is performed in the printing step. In the printing step of the present example, the printer 16 directly ejects the ink for textile printing onto the medium that ultimately becomes the product. Therefore, the printing step executed in the present example can also be considered as, for example, a step of performing direct textile printing.

In this case, the steaming machine 18 and the washing machine 20 are an example of a post-processing machine that executes a post-processing step performed after the printing step. The post-processing machine can also be considered as, for example, a device that executes the post-processing step on a printed matter obtained by performing the printing step with the printer 16.

The steaming machine 18 is an example of a color development processing machine, and executes a steaming step (steaming process) on the fabric on which the information is printed. In this case, the steaming step can be considered as, for example, a color developing step of performing the color development process of causing the ink to develop color by steaming the fabric, to which the ink for textile printing is attached, with high temperature steam.

In this case, in the steaming machine 18, the color developing step on the ink used in the printing step can be considered as being executed as the post-processing step.

The color development process performed in the steaming machine 18 can be considered as a color development process or the like when performing textile printing on a fabric medium. Furthermore, this color development process can also be considered as, for example, a process of fixing the color after printing.

In the present example, the steaming machine 18 executes the steaming process under the steaming condition designated in the set production condition. Thus, the steaming machine 18 creates a steamed printed matter according to the production condition.

The washing machine 20 is a device that executes a washing step. The washing step is a step of washing the printed matter after the color development process.

The washing step can be considered as, for example, a step of washing the medium after the ink is ejected in the printing step. In this case, the washing step can also be considered as a step of removing excess ink and coating agent attached to the fabric after printing.

In the present example, the washing machine 20 executes the washing step under the washing condition designated in the set production condition. As a result, a printed matter subjected to the washing process according to the set production condition is obtained. Furthermore, in the present example, the printed matter after the washing process can be considered as a product created in the printing system 10.

As described above, according to the present example, the product of printing can be appropriately created. Furthermore, each step (pre-processing step, printing step, and post-processing step) performed to create a product can be intensively managed in the control device 12 by managing the production conditions in the control device 12. In this case, instructions and the like to the worker can be appropriately performed according to the production conditions set in the control device 12 by managing the condition of each step by the control device 12 in the printing system 10. Thus, on the worker side, the work (e.g., manual operation or the like for each device) necessary for creating the product of printing can be easily and appropriately performed without being conscious of the production conditions and the like.

For example, in the printing system having the conventional configuration in which each step is not intensively managed by the control device 12, when creating a product of printing through a plurality of steps such as a pre-processing step, a printing step, and a post-processing step, each step is usually performed independently, for example, at different bases. The condition of each step is also managed individually in each step. As a result, in the printing system having the conventional configuration, in each step, work is often performed depending on the skilled technique, skill, or the like of the worker. In particular, the pre-processing step and the post-processing step are largely dependent on the skilled techniques and skills of the worker, the know-how accumulated individually, and the like.

In addition, since a skilled skill or the like is required for each step, in the conventional configuration, the pre-processing step and the post-post-processing step are often outsourced to a specialized contractor. Therefore, in a case of a conventional configuration, it has been difficult to perform in-house manufacturing or the like in which the pre-processing step and the post-processing step are also performed by the company itself in a company or the like that performs a printing step. In addition, since various conditions and skills are required for every step, for example, if human resources capable of performing work of a plurality of steps are to be developed, it takes a long time and a large amount of cost. Therefore, with the conventional configuration of the printing system, even if the pre-processing step and the post-processing step are in-house manufactured, for example, unevenness is likely to occur in quality due to increase in the dependence on a person (dependence on the personal qualities of the worker) for the pre-processing step and the post-processing step.

On the other hand, in the present example, for example, the condition of each step can be set without depending on the skilled technique, skill, and the like of the worker by managing the production conditions in the control device 12. In the present example, a point or the like at the time of production can be accurately instructed to the worker by displaying on the monitor or the like.

In this case, the control device 12, instead of a person, can manage the know-hows and cautions in each step, which are personally stored by the worker in the conventional configuration.

Therefore, according to the present example, even a worker who does not have a skilled technique or skill can more appropriately operate the device used in each step, or the like. Furthermore, for example, it is thus possible to stably produce a product of printing without taking time and effort for human resource development and the like. In this case, each step can be appropriately executed even if the worker changes. Therefore, for example, it is also possible to prevent the entire production operation from stopping due to the absence of the person in charge of some steps.

In the present example, it is possible to transmit (e.g., automatic transmission) the production condition of each step from the control device 12 to each device via a network. In this case, for example, it is possible that a worker performs only the work that requires human hands, such as replenishment of consumables in each device, transportation of articles, and the like, and for the setting of the production condition of the step, the control device 12 directly controls each device.

With this configuration, automation of steps, reduction of human errors, and the like can be appropriately performed. Even when a plurality of workers alternately perform work in one step, a product can be normally and appropriately produced without orally making instructions, inquiries, confirmations, and the like.

In the present example, the quality of the product can be stabilized by automatically setting various conditions (e.g., fine conditions in the pre-processing step and the post-processing step, etc.) that affect the quality of the product with the control device 12. Therefore, according to the present example, the pre-processing step and the post-processing step can be performed without depending on the personal technique, skill, or the like of the worker. This also allows for easier and more appropriate in-house manufacturing of textile production.

Here, each device constituting the printing system 10 does not necessarily need to be installed in the same place (base, factory, etc.). It may be installed and operated at a remote place.

For example, the following is conceivable.

The pre-processing step, the printing step, and the post-processing step are executed at different places from each other.

Furthermore, some of the plurality of steps (e.g., a post-processing step and a printing step) are performed at the same place and other steps (e.g., a pre-processing step) are executed at other places (e.g., a remote place).

According to such configuration, the scale of the printing system 10 can be more easily enlarged, as necessary. In such a case as well, the product of printing can be appropriately created by managing the conditions and the like of each step using the control device 12.

In the present example, the fabric used as the medium is sequentially supplied to each device constituting the printing system 10, and various processes are performed on the fabric in the step performed in each device.

Thus, it is preferable to uniquely identify the medium (product produced in each step) on which each step has been performed using, for example, ID or the like. For example, it is conceivable that an ID for uniquely identifying each fabric is issued, and a label or the like indicating the ID is attached to the fabric. As the ID, for example, it is conceivable to use a QR code (registered trademark), a barcode, or the like. In this case, it is conceivable to read the ID with an ID reading device before executing each step or the like and inquire the control device 12 to display the appropriate condition of the step, in which the fabric given the ID is supplied, on the display unit or the like of the device performing the step.

According to such configuration, in each step performed to create the product, the condition suitable for the fabric to be processed can be appropriately used. This makes it possible to appropriately reduce production errors and the like.

Furthermore, as described above, in the present example, the control device 12 sets the production condition, for example, according to an instruction of an administrator of the printing system 10. Moreover, the control device 12 adjusts the condition of each step executed in the printing system 10, as necessary. In this case, in the control device 12, for example, it is conceivable to determine a condition of a certain step based on a condition of another step. In the present example, the control device 12 determines the condition of the washing step based on the condition of another step.

Hereinafter, a manner of determining the condition of the washing step, and the like will be described in detail.

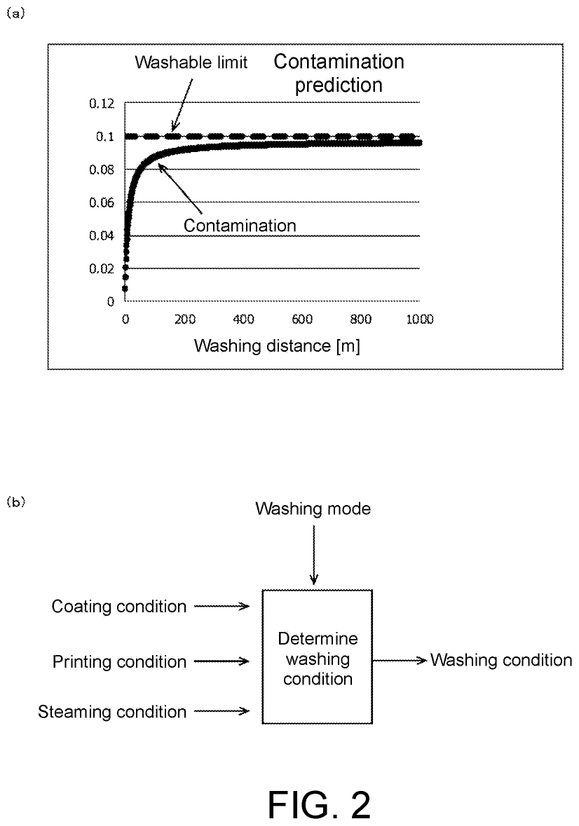

FIG. 2 is a view describing a manner of determining a condition of a washing step.

(a) of FIG. 2 is a view describing contamination of washing water (washing liquid) generated during washing. (a) of FIG. 2 shows an example of a result (contamination prediction) of predicting the progress of contamination of the washing water generated when washing of the printed matter created in the printing step is performed under a predetermined condition.

In this case, the washing water can also be considered as, for example, a liquid obtained by adding a chemical agent or the like to water. (a) of FIG. 2 shows an example of contamination prediction when cotton broad is used as the medium and a reactive dyed ink is used as the ink.

In the washing, the medium is conveyed while immersing the medium or printed matter in the washing water of a determined volume to perform washing on each position of the medium. In this case, it can be considered that the washing distance indicated on the horizontal axis of the graph is proportional to the amount of medium that has been subjected to washing. Furthermore, in the graph, the vertical axis indicates the contamination degree of the washing water when a value at a washing limit is 0.1.

The washing limit can be considered as, for example, a limit of contamination at which washing determined according to the condition of the washing step becomes difficult. In addition, at the time of washing, it is conceivable that the contamination degree does not exceed the washing limit as illustrated in (a) of FIG. 2 by replacing the washing water at a rate.

Here, when executing the washing step in the washing machine 20, a large amount of water (washing water) and energy are usually required in order to appropriately secure the quality of the product of printing. The energy required in the washing step is, for example, energy required for driving the washing machine 20. When water or energy is consumed more than necessary in the case of executing the washing step, an excessive load on the environment is generated by that amount. On the other hand, when the used amount of water or energy is excessively reduced, washing may become insufficient.

For example, the washing step cannot be appropriately performed under a condition where the contamination of the washing water exceeds the washable limit. Then, washing (rewashing) and the like are required again, and additional energy is required for additional work time, water, and driving of the washing machine 20, replacement of water, and the like.

Therefore, in the washing step, it is important to appropriately determine the conditions of the step so that the used amount of water or energy falls within an appropriate range. For example, it is preferable that a contamination degree of the washing water does not exceed a washable limit while minimizing a volume of washing water stored in a bath (washing tank) that stores washing water, a rate of washing water to be replaced in unit time, and the like as much as possible.

In this regard, for example, a condition of an appropriate step can be set, for example, by actually performing washing and setting the condition of the washing step. However, in order to determine the optimum condition of the washing step for various printed matters created in the printing step, it is necessary to check every time, and work time, water, energy, and the like therefor are necessary.

In addition, when actually performing the washing and setting the condition of the washing step, for example, it is conceivable that the worker of the washing step sets the condition of the washing step by checking the washing result. However, in this case, the dependence on the technology, know-how, and the like personally possessed by the worker increases, and unevenness and the like easily occur in the quality of washing by the person in charge of performing the work. In addition, due to the decrease in the labor population in recent years, it can be assumed that the inheritance of technology becomes difficult in such a method that relies on personal technology, know-how, and the like.

On the other hand, in the present example, the control device 12 adjusts the condition of each step executed in the printing system 10, as necessary. In the present example, the control device 12 determines the condition of the washing step based on the conditions of other steps such as the printing step.

According to such configuration, the condition of the washing step suitable for the printed matter created in the printing step can be appropriately determined without actually performing washing. In this case, unevenness or the like can be appropriately prevented from occurring in the quality of washing even when the person in charge of the work changes by determining the condition of the washing step without relying on the technology, know-how, or the like personally possessed by the worker. As a result, even in a case where the decrease in labor population has progressed, workers can be more easily and appropriately secured.

IT is considered that conditions of the washing step are performed as shown in (b) of FIG. 2. (b) of FIG. 2 shows one example of a manner of determining the condition of the washing step. In the present example, the control device 12 determines the condition of the washing step (washing condition) based on at least a part of the condition of the coating step executed in the coating machine 14 (coating condition), the condition of the printing step executed in the printer 16 (printing condition), the condition of the steaming step executed in the steaming machine 18 (steaming condition), and the washing mode.

The control device 12 at least determines the condition of the washing step based on the condition of the printing step. The coating condition is an example of the condition of the pre-processing step. The steaming condition is an example of the condition of the post-processing step excluding the washing step. The steaming condition can also be considered as, for example, a condition of the post-processing step executed before the washing step. The operation of determining the condition of the washing step based on the steaming condition can be considered as, for example, an example of an operation of determining the condition of any post-processing step based on the condition of another post-processing step when performing a plurality of post-processing steps.

In addition, the washing mode can be considered as, for example, a parameter indicating a matter to be prioritized at the time of executing the washing step. In this example, a plurality of washing modes in which items to be prioritized are different from each other are set in advance. The control device 12 receives, for example, an instruction as to which washing mode among the plurality of washing modes is to be executed at the time of executing the washing step from a user such as an administrator. The matter to be prioritized at the time of executing the washing step can also be considered as a user's purpose related to the washing step.

According to the present example, by determining the condition of the washing step based on the condition of each step executed in the printing system 10, the condition of the washing step can be appropriately determined according to the content of the step executed in each step.

In addition, by executing the washing step in the washing machine 20 based on the determined condition of the washing step, the washing step can be appropriately executed while preventing excess or deficiency of water and energy consumption from occurring without depending on the skilled technique, skill, or the like of the worker. As a result, it is also possible to reduce the environmental load generated in the washing step.

In the present example, the control device 12 determines the condition of the washing step based on the washing mode selected by the user. In this case, by calculating the washable condition based on the washing mode and the condition of each step, for example, a more appropriate condition of the washing step suited for the washing mode can be determined. According to the present example, the condition of the washing step can be appropriately determined according to the matter prioritized at the time of washing. In this case, by determining the condition of washing according to the washing property or the like set for the respective washing mode, washing with necessary washing property can be appropriately performed according to the purpose of the user. As a result, for example, problems such as a trouble of insufficient washing and production of a defective product can be appropriately prevented in advance. As the washing property for each washing mode, for example, it is conceivable to set parameters or the like in consideration of the fastness of the product and the prediction of contamination of the washing water.

Furthermore, regarding the washing mode, for example, it is conceivable to prepare a mode according to the purpose such as productivity and quality. According to such configuration, for example, the condition of the washing step can be more appropriately determined according to the purpose of the user, and the like. As the washing mode, for example, it is conceivable to prepare a mode in which quality is prioritized, a mode in which cost reduction is prioritized, a mode in which productivity improvement is prioritized, and the like. In this case, as a mode in which cost reduction is prioritized, it is conceivable to use a mode in which reduction in the used amount of washing water is prioritized. In this case, as a mode in which reduction in used amount of washing water is prioritized, it is conceivable to use a mode in which a condition of the used amount of the washing water is designated. As a mode in which production improvement is prioritized, it is conceivable to use a mode in which the washing time is shortened. As the washing mode, for example, it is also conceivable to use a mode in which priority is given to continuously performing washing for a longer time (mode of continuously performing long-distance washing).

For the condition of the washing step, it is conceivable to determine the condition of the washing step corresponding to the respective washing mode with respect to a plurality of washing modes, instead of determining based on the washing mode designated by the user.

In this case, the control device 12 determines, for example, a plurality of conditions corresponding to a plurality of washing modes as the condition of the washing step, and proposes the condition to the user. According to such configuration, for example, the condition of the washing step can be more appropriately determined according to the purpose of the user.

In the present example, the control device 12 at least determines a used amount of the washing water as a condition of the washing step. With such a configuration, in the washing step, the used amount of washing water can be appropriately prevented from becoming excess or insufficient, and the like. It is conceivable to determine a volume of washing water stored in a bath for storing washing water, a rate of washing water to be replaced in a unit time, and the like as the used amount of washing water. The rate of washing water to be replaced in unit time can also be considered as a parameter corresponding to the amount of flowing the washing water.

The control device 12 may further determine, for example, how to move the medium in the washing step (e.g., a moving speed or the like) and the like as the condition of the washing step. According to such configuration, the energy and the like consumed in the washing step can be appropriately changed according to the condition of each step such as the printing step.

Determining the conditions of the washing step can also be considered as, for example, an example of an operation of predicting the amount of washing water and energy necessary for washing. In this case, by executing the washing step under the condition of consuming the minimum necessary amount of washing water and energy, the necessary washing property can be appropriately secured without consuming an unnecessarily large amount of washing water and energy. Accordingly, energy saving and water saving can be appropriately performed in the washing step.

In this case, the condition of the washing step that can secure the necessary washing property can be appropriately proposed. As a result, it is also possible to appropriately prevent the washing in the washing step from becoming insufficient and the re-washing (plural washing) from becoming necessary. The manner of determining the condition of the washing step in this example can also be considered as, for example, a method for automatically determining the condition of the washing step based on the condition of each step. In this case, for example, the confirmation work and the like by the user for setting the optimum washing method can be appropriately reduced by determining the condition of the washing step based on the condition of each step and the like. In this case, even in a case where a worker who does not have sufficient technology and know-how related to the washing step performs a work, washing at a constant quality can be appropriately performed by determining the condition of the washing step in the control device 12. As a result, it is also possible to produce products of the same quality more appropriately at various bases in the world.

When determining the conditions of the washing step, the control device 12 may further consider matters related to the washing step. For example, the amount of washing water required at the time of washing is considered to change depending on the temperature of the washing water or the like. Therefore, for example, control device 12 may determine the used amount of washing water based, for example, further on the temperature of washing water. In the washing step, for example, it is conceivable to adjust the temperature of washing water by heating washing water or the like. In such a case, the control device 12 may determine the temperature of the washing water, or the like as a condition of the washing step. As the condition of the washing step, for example, matters other than the above may be determined as necessary.

Hereinafter, a manner of determining the condition of the washing step, and the like will be described in further detail. As described above, in the present example, the control device 12 determines the condition of the washing step based on various conditions used as conditions of each step such as the printing step. In this case, in the control device 12, for example, it is conceivable to determine a condition of the washing step based on a database prepared in advance. In this case, for example, the control device 12 calculates the amount of excess ink (excess dye) existing on the medium immediately before executing the washing step, and the like based on various conditions of each step. Then, the contamination status of the washing water for each condition (e.g., conveyance speed, temperature, etc.) of the washing step is predicted using the database from the calculated value. Based on the prediction result, a washable condition that does not adversely affect the product of printing is derived, and the condition of the washing step is determined based on the washable condition.

In this case, regarding the operation of the control device 12, for example, it can be considered that various information regarding each step is stored in the storage means, and the condition of the washing step is determined based on this information. In this case, it is conceivable to use, for example, a fabric used as a medium, a pre-processing agent (chemical solution to be applied) used in a pre-processing step, information regarding a printing step, and the like as the information. The function of determining the condition of the washing step in the control device 12 can also be considered as, for example, a function of a washing prediction system. The washing prediction system can also be considered as, for example, a system that determines the condition of the washing step by extracting the condition of each step to be executed before the washing step and inputting necessary parameters to the washing prediction system.

In the control device 12, for example, it is conceivable to determine a condition of the washing step by performing a selection from a plurality of conditions prepared in advance. In this case, these plurality of conditions can be considered as an example of selectable conditions of the post-processing step. According to such a configuration, the condition of the washing step can be easily and appropriately determined. The conditions of the washing step are not limited to the method using the database as described above, and may be determined by other various methods. For example, it is also conceivable to determine the condition of the washing step using a calculation formula stored in the storage means of the control device 12. In this case, this calculation formula can be considered as, for example, a calculation formula used when outputting information for performing washing.

It is also conceivable that the condition of the washing step is, for example, determined using artificial intelligence. In this case, the control device 12 has a function of learning, for example, the relationship between the condition of each step such as the printing step and the condition of the washing step. In this case, it is conceivable to use a condition prepared by performing the learning as at least a part of a plurality of conditions prepared in advance as the selectable conditions of the washing step. The control device 12 performs, for example, machine learning as learning. For example, it is conceivable to perform deep learning as the machine learning. With this configuration, for example, the control device 12 can be appropriately caused to perform learning.

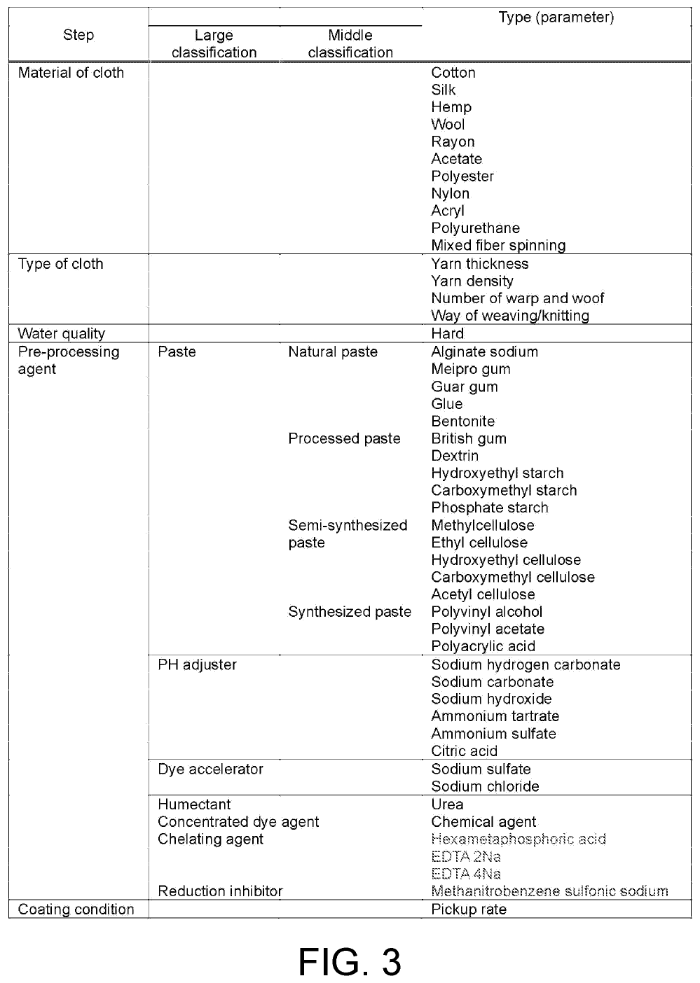

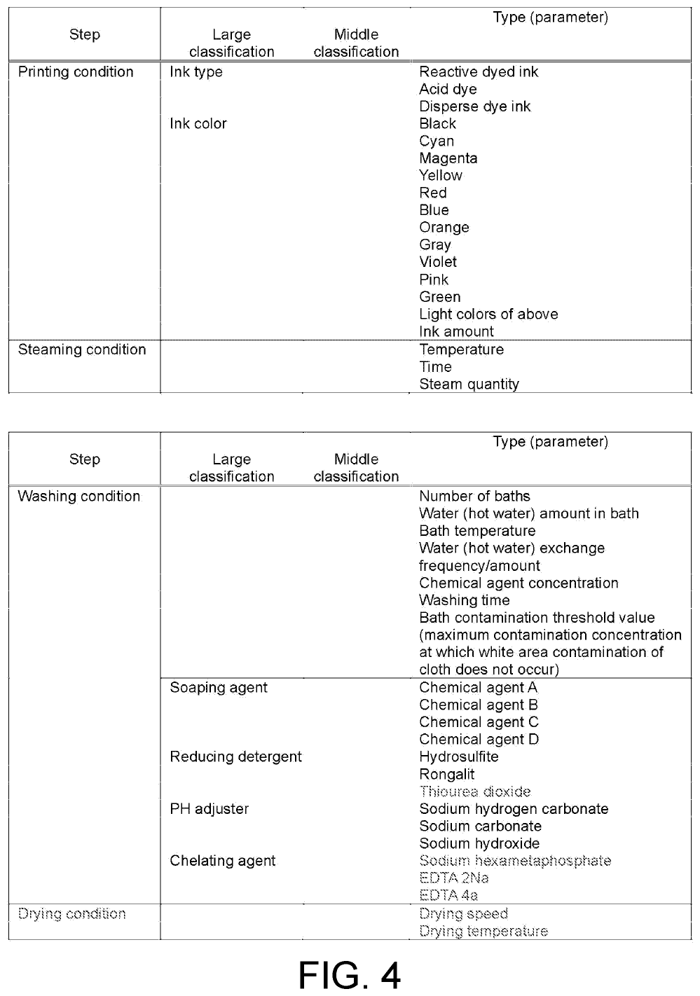

Parameters and the like to be considered when determining the conditions (washing conditions) of the washing step will be described in more detail. The parameters considered at the time of determining the condition of the washing step is a parameter indicating the condition of each step considered at the time of determining the condition of the washing step. As such a parameter, for example, it is conceivable to use at least some of the various parameters illustrated in FIGS. 3 and 4.

FIGS. 3 and 4 are views showing an example of a parameter to take into consideration at the time of determining the condition of the washing step. FIGS. 3 and 4 show examples of various conditions regarding each step executed in the printing system 10. The control device 12 determines the condition of the washing step using, for example, at least some of the parameters illustrated in FIGS. 3 and 4. FIGS. 3 and 4 illustrate examples of various parameters that can be used as examples of parameters to be considered at the time of determining the condition of the washing step and parameters to be determined as the condition of the washing step. At the time of actually determining the conditions of the washing step, not all the illustrated parameters are necessarily used, and it is conceivable to use some parameters as necessary. In this case, the control device 12 determines the condition of the washing step based on, for example, a plurality of parameters among the parameters illustrated in FIGS. 3 and 4.

In the present example, the control device 12 determines the condition of the washing step (washing condition) based on at least a part of the condition of the coating step executed in the coating machine 14 (coating condition), the condition of the printing step executed in the printer 16 (printing condition), the condition of the steaming step executed in the steaming machine 18 (steaming condition), and the washing mode. In this case, the control device 12 may determine the condition of the washing step while further considering the matters directly related to the washing step. For example, in the control device 12, the condition of the washing step is preferably determined based on the type of fabric used as the medium. As the type of fabric, for example, as shown in the figure, it is conceivable to take into consideration the material of the cloth, the type of cloth, and the like. Preferable conditions of the washing step may vary depending on the water quality of the washing water to use. Therefore, the control device 12 may determine the condition of the washing step based on the water quality of the washing water. As the water quality, for example, consideration is made to the hardness of water, and the like.

At the time of determining the condition of the washing step in the control device 12, it is conceivable to consider, for example, the type of pre-processing agent as the coating conditions. As the type of pre-processing agent, for example, as shown in the figure, it is conceivable to take into consideration the type of paste, and the like used as a main component of the pre-processing agent. The control device 12 may further consider components of the pre-processing agent other than the paste with respect to the type of the pre-processing agent. In this case, for example, it is conceivable to consider a substance used as a pH adjuster, a dye accelerator, a humectant, a concentrated dye agent, a chelating agent, a reduction inhibitor, or the like. Consideration is also made to, for example, a pickup rate of the coating and the like as the coating condition. It is also considered to perform the pre-processing on the medium through an inkjet method using an inkjet head. In this case, consideration is also made to selectively apply the pre-processing agent to only a part of the medium. As a result, the amount of the pre-processing agent to be applied to the medium may be changed variously. In such a case, it is preferable to consider the application amount of the pre-processing agent as the coating condition.

At the time of determining the condition of the washing step in the control device 12, it is conceivable to consider, for example, the type of ink ejected in the printing step, as shown in the figure, as the printing condition. As the condition of the printing step, it is preferable to further consider the amount of ink ejected onto the medium in the printing step. The amount of ink is preferably calculated based on, for example, print data indicating an image to be printed. The amount of ink can also be considered as, for example, a parameter corresponding to the printing amount in the printing step.

In the printing step, for example, consideration is made to perform color printing using inks of a plurality of colors in the printer 16. In this case, as shown in the figure, for example, the color of the ink used in the printing step is preferably further considered as the condition of the printing step. When inks of a plurality of colors are used in the printing step, it is considered that the degree of influence on contamination occurring in the washing water in the washing step may differ depending on the color of the ink. As a result, it is conceivable that a difference occurs in the washable region for every color of the ink. Therefore, it is preferable to consider the amount of ink for every color as the amount of ink to be considered at the time of determining the condition of the washing step. In this case, the control device 12 determines the condition of the washing step based on the amount of ink of each color, for example, so as to cover the color of the ink ejected to the medium in the printing step.

In the printing step, it is also conceivable to use a so-called light color ink (light ink, pale ink) as a part of the inks of a plurality of colors. In this case, it is conceivable that a difference occurs between the ink of normal strength (dark ink) of the same color and the ink of light color with respect to the degree of influence on the contamination occurring in the washing water in the washing step. Therefore, regarding the amount of ink of each color ejected to the medium in the printing step, for example, it is preferable to further consider the difference in color strength for the ink of the same color having different color strengths. In this case, the control device 12 determines the condition of the washing step based on, for example, the amount of ink of each color adjusted according to the color strength.

In order to determine the conditions of the washing step with a higher accuracy, it is considered important to consider the condition of the printing step among the steps executed in the printing system 10. In this case, for example, it is more preferable to consider a plurality of conditions regarding the printing step. In this case, the type of fabric used as the medium can also be considered as a condition of the printing step. In this case, the control device 12 at least preferably determines the condition of the washing step based on the type of fabric used as the medium, the amount of ink ejected onto the medium in the printing step, and the type of ink ejected in the printing step. In the modified example of the printing system 10, depending on the conditions required for the washing step, consideration may be made to only consider the condition of the steps other than the printing step, for example, at the time of determining the condition of the washing step. In this case, for example, consideration is made to determine the condition of the washing step based on the condition of the pre-processing step and the like without considering the condition of the printing step.

At the time of determining the condition of the washing step in the control device 12, it is conceivable to consider, for example, the temperature, time, steam quantity, and the like in the steaming step, as shown in the figure, as the steaming condition. When the steaming step is performed, it is conceivable that the amount of ink remaining without fixing to the medium changes according to the steaming condition. In this case, for example, the condition of the washing step can be adjusted according to the amount of ink remaining without fixing to the medium by determining the condition of the washing step based on the steaming condition.

As described above, in the present example, the control device 12 can appropriately determine the condition of the washing step based on, for example, the coating condition, the printing condition, and the steaming condition by considering various parameters as described above. In this case, as described above, it is conceivable to determine the condition of the washing step according to the washing mode. According to the present example, for example, the condition of the washing step can be appropriately determined based on the condition of each step executed in the printing system 10.

In the control device 12, it is conceivable to determine at least some of the parameters indicated as the washing condition in the figure as the condition of the washing step. As the condition of the washing step, for example, it is conceivable to determine the number of baths to use at the time of washing, how to use water or hot water (warm water) stored as washing water in the bath, the concentration of a chemical agent to be added to the washing water, the washing time, the threshold of bath contamination, and the like. In this case, the threshold of the bath contamination can be considered as, for example, the maximum contamination concentration at which white water contamination does not occur in the cloth (medium) to be washed. Regarding how to use the water or hot water stored as the washing water in the bath, for example, it is conceivable to determine the amount to be stored, the bath temperature, the frequency of replacement, the amount of replacement, and the like. The bath temperature can be considered as, for example, a temperature of washing water. The washing time can be considered as, for example, a time to perform the operation of washing. A necessary washing time can be appropriately secured, for example, by determining the washing time as a condition of the washing step. As a condition of the washing step, for example, it is also conceivable to determine a type of a chemical agent or the like to be added to the washing water. In this case, for example, as shown in the figure, it is conceivable to determine a substance to use, a product, and the like for the soaping agent, the reducing detergent, the pH adjuster, the chelating agent, and the like.

In the printing system 10, it is conceivable to further execute a drying step of drying the medium after executing the washing step in the washing machine 20. In this case, the printing system 10 further includes, for example, a drying device that executes a drying step. In this case, in the control device 12, for example, it is conceivable to determine the condition of the drying step in accordance with the condition of the washing step to be determined. As the drying condition, for example, it is conceivable to determine a drying speed, a drying time, and the like. According to such configuration, the medium after washing can be appropriately dried, and the product of printing can be appropriately created. In the printing system 10, for example, it is conceivable to execute the drying step using a drying condition set in advance. In this case, the control device 12 may determine the condition of the washing step further based on a drying condition set in advance. According to such configuration, for example, the condition of the washing step can be more appropriately determined according to the condition of the step performed after the washing step.

Next, supplementary description regarding each configuration described above, description on a modified example, and the like will be made. As described above, in the present example, the condition of the washing step can be appropriately determined based on conditions of each step such as the printing step. In this case, it is also possible to roughly predict, for example, the amount of drainage generated at the time of washing, the degree of contamination, and the like from the conditions of the washing step and the like. As a result, it is also possible to easily and appropriately select an optimal disposal method for drainage in conformity to each legal regulation.

In the present example, the washing machine 20 executes the washing step according to the condition of the washing step determined in the control device 12. However, at the time of actual execution of the washing step, consideration is made that contamination may occur in the washing water due to an unexpected cause. Therefore, in the washing machine 20, it is preferable to execute the washing step while monitoring the operating status of the system such as the contamination status of the washing water. In this case, it is also conceivable to adjust the condition of the washing step determined before the start of the washing step during the execution of the washing step according to the contamination status of the washing water or the like. In this case, for example, it is also conceivable to add or replace washing water, as necessary, based on a contamination status of the washing water or the like. According to such a configuration, the operation of the washing step can be more appropriately controlled.

In the above description, the operation in the case where the condition of the washing step is determined based on the condition of each step has been mainly described. However, when attempting to determine the condition of the washing step with higher accuracy, for example, the state of the medium after each step is performed may be detected, and the washing step may be determined based further on the detection result. In this case, for example, consideration is made to determine the condition of the washing step based further on the state of the printed matter obtained by the printing step. In this case, as the state of the printed matter, for example, it is conceivable to detect the color state of the ink of each color used for printing, and the like. As the state of the medium after each step is performed, for example, it is conceivable to detect the state of the medium after the coating step is performed. In this case, it is conceivable to detect the state of the pre-processing agent applied to the medium and determine the condition of the washing step based on the detection result. In these cases, it is conceivable to determine the condition of the washing step based on the detection result of the state of the medium so that a washing failure (residue of coloring material etc.) of the product does not occur.

As described above, in the present example, the control device 12 determines the condition of the washing step based on the condition of the step other than the washing step. Considering such an operation in a more generalized manner, it can be considered that the condition of any step is determined based on the condition of another step with respect to a plurality of steps performed in the printing system 10. In the printing system 10, the condition of each step other than the washing step may be determined based on the condition of another step. In this case, in the control device 12, for example, consideration is made to determine the condition of the printing step based on the condition of the post-processing step such as the washing step According to such configuration, when executing the printing step and the post-processing step, the condition of the printing step can be more appropriately determined. In this case, in the control device 12, for example, consideration is made to determine the condition of the printing step based on the condition of the washing step so that the printing speed in the printing step matches the speed of washing the medium in the washing step. According to such configuration, the printing speed can be appropriately adjusted according to the time required to execute the washing step under an optimum condition.

### INDUSTRIAL APPLICABILITY

The present invention can be suitably used, for example, in a printing system.

### REFERENCE SIGNS LIST

10 Printing system,

12 Control device

14 Coating machine

16 Printer

18 Steaming machine

20 Washing machine

1. A printing system that creates a product of printing by performing at least printing, the printing system comprising:
a printing apparatus that executes a printing step of performing printing by ejecting ink;
a post-processing machine that is a device configured to execute a post-processing step on a printed matter obtained by performing the printing step in the printing apparatus; and
a controller that determines a condition of the post-processing step based on a condition of the printing step.

2. The printing system as set forth in claim 1, wherein
the printing step is a step of ejecting ink onto a fabric medium,
the post-processing step is a washing step of washing the medium after the ink is ejected in the printing step,
the controller determines a condition of the washing step based on a condition of the printing step, and
the post-processing machine executes the washing step under a condition of the washing step determined by the controller.

3. The printing system as set forth in claim 2, wherein the controller at least determines a condition of the washing step based on a type of fabric used as the medium.

4. The printing system as set forth in claim 2, wherein the controller at least determines a condition of the washing step based on an amount of ink ejected onto the medium in the printing step.

5. The printing system as set forth in claim 4, wherein
the printing apparatus performs printing on the medium using inks of a plurality of colors in the printing step, and
the controller at least determines a condition of the washing step based on an amount of ink of each color ejected to the medium in the printing step.

6. The printing system as set forth in claim 2, wherein the controller at least determines a condition of the washing step based on a type of ink ejected in the printing step.

7. The printing system as set forth in claim 2, wherein the controller at least determines a condition of the washing step based on a type of fabric used as the medium, an amount of ink ejected onto the medium in the printing step, and a type of ink ejected in the printing step.

8. The printing system as set forth in claim 2, wherein
the printing step is a step of ejecting ink that requires color development process,
the printing system further includes a color development processing machine that executes a color developing step of performing the color development process, and
the controller determines the condition of the washing step further based on the condition of the color developing step.

9. The printing system as set forth in claim 2, further comprising:
a pre-processing machine that is a device configured to execute a pre-processing step on a fabric used as the medium in the printing step; wherein
the controller determines the condition of the washing step further based on the condition of the pre-processing step.

10. The printing system as set forth in claim 9, wherein
the pre-processing step is a step of applying a pre-processing agent on a fabric used as the medium; and
the controller at least determines a condition of the washing step based on a type of the pre-processing agent used in the pre-processing step.

11. The printing system as set forth in claim 2, wherein the controller at least determines a used amount of a washing water, that is water for washing, as a condition of the washing step.

12. The printing system as set forth in claim 2, wherein the controller at least determines a temperature of a washing water, that is water for washing, as a condition of the washing step.

13. The printing system as set forth in claim 2, wherein the controller at least determines a washing time as a condition of the washing step.

14. The printing system as set forth in claim 2, wherein the controller receives, from a user, an instruction to select one of a plurality of washing modes in which matters to be prioritized at the time of executing the washing step are different from each other, and determines a condition of the washing step according to the washing mode selected by the user.

15. A printing system that creates a product of printing by performing at least printing, the printing system comprising:
a printing apparatus that executes a printing step of performing printing by ejecting ink;
a pre-processing machine that is a device configured to execute a pre-processing step before the printing step to create the product;
a post-processing machine that is a device configured to execute a post-processing step on a printed matter obtained by performing the printing step in the printing apparatus; and
a controller that determines a condition of the post-processing step based on a condition of the pre-processing step.

16. A printing system that creates a product of printing by performing at least printing, the printing system comprising:
a printing apparatus that executes a printing step of performing printing by ejecting ink;
a post-processing machine that is a device configured to execute a post-processing step on a printed matter obtained by performing the printing step in the printing apparatus; and
a controller that determines a condition of the printing step based on a condition of the post-processing step.

17. The printing system as set forth in claim 16, wherein
the printing step is a step of ejecting ink onto a fabric medium,
the post-processing step is a washing step of washing the medium after the ink is ejected in the printing step, and
the controller determines a condition of the printing step based on the condition of the washing step so that a printing speed in the printing step becomes a speed corresponding to the speed of washing the medium in the washing step.

18. (canceled)

19. (canceled)

20. (canceled)

21. (canceled)

22. (canceled)

23. (canceled)

24. The printing system as set forth in claim 3, wherein the controller at least determines a condition of the washing step based on an amount of ink ejected onto the medium in the printing step.

25. The printing system as set forth in claim 3, wherein the controller at least determines a condition of the washing step based on a type of ink ejected in the printing step.

26. The printing system as set forth in claim 4, wherein the controller at least determines a condition of the washing step based on a type of ink ejected in the printing step.
